(19) United States
(12) Patent Application Publication
(10) Pub. No.: US 2024/0410339 A1
(43) Pub. Date: Dec. 12, 2024

(54) ONLINE INDIRECT MEASUREMENT METHOD FOR PITCHING AND YAWING MOMENTS OF WIND OR TIDAL CURRENT TURBINE

(71) Applicant: ZHEJIANG UNIVERSITY, Zhejiang (CN)

(72) Inventors: Yajing GU, Zhejiang (CN); Hongwei LIU, Zhejiang (CN); Haitao LI, Zhejiang (CN); Yonggang LIN, Zhejiang (CN); Wei LI, Zhejiang (CN)

(73) Assignee: ZHEJIANG UNIVERSITY, Zhejiang (CN)

(21) Appl. No.: 18/811,661

(22) Filed: Aug. 21, 2024

Related U.S. Application Data
(63) Continuation-in-part of application No. PCT/CN2022/130979, filed on Nov. 9, 2022.

(30) Foreign Application Priority Data
Mar. 1, 2022 (CN) 202210194300.2

(51) Int. Cl. F03D 17/00

(52) U.S. Cl. CPC F03D 17/029; F05B 2270/328; F05B 2270/329

(57) ABSTRACT

An online indirect measurement method for pitching and yawing moments of a wind or tidal current turbine is provided. The method uses an online indirect measurement system including an incoming flow velocity measurement module, a generator rotation speed measurement module, a pitch angle measurement module, and a computer; the incoming flow velocity measurement module measures the flow velocity of the rotor center; the generator rotation speed measurement module measures the generator rotation speed; the pitch angle measurement module measures the pitch angle of each blade; the computer receives signals of flow velocity, generator rotation speed, and pitch angle, obtains the pitching moment and yawing moments of the turbine via an online calculation, and displays and stores the measured and calculated data in real time.

### CROSS-REFERENCE TO RELATED APPLICATION

This is a continuation-in-part application of International Application No. PCT/CN2022/130979, filed on Nov. 9, 2022, which claims the priority benefits of China Application No. 202210194300.2, filed on Mar. 1, 2022. The entirety of each of the above-mentioned patent applications is hereby incorporated by reference herein and made a part of this specification.

### BACKGROUND OF THE INVENTION

### Field of the Invention

The invention belongs to the field of renewable energy power generation equipment, and specifically relates to an online indirect measurement method for the pitching and yawing moments of a wind or tidal current turbine.

### Description of Related Art

As an emerging renewable energy equipment, wind power generation equipment has been applied on a large scale, and tidal current power generation equipment has completed the development stage from principle verification to industrial prototype. At present, equipment operation reliability and cost have become bottlenecks in the development of the wind energy and tidal current power generation industries. In particular, online measurement techniques of asymmetric loads such as pitching moment and yawing moment of the turbine are key techniques.

The accuracy of online measurement of asymmetric loads affects the real-time operating status monitoring and the active load control of the turbine, which is related to the safety and reliability of the entire unit operation; at the same time, the accuracy of asymmetric load measurement also indirectly affects the safety margin issue in design process of the turbine, thus affecting the design and operation and maintenance costs.

For wind or tidal current power generation equipment, the existing techniques mostly adopt direct measurement methods, such as mounting strain gauges or fiber Bragg grating sensors for load measurement. For example, in the Chinese patent “Offshore Wind Turbine Load Testing Device and Method”, Publication No. CN113250915A, a plurality of strain gauge sensors are arranged at the blade root, blade center, main shaft, tower, and other locations of the wind turbine respectively. Each strain gauge sensor is connected to an industrial computer via a data collector. The industrial computer obtains the stress statistical average values of each sensor and calculates the loads at different positions; in the Chinese patent “Wind Turbine Blade Load Measurement Method and Application Based on FBG”, Publication No. CN112665766A, a set of corresponding fiber grating sensors is disposed on each blade of the wind turbine, the output wavelength change values of the sensor group are measured, and the real-time loads of each blade are obtained via calculation. This type of direct measurement method has the following disadvantages: mounting sensors at positions on the rotating components of the turbine such as blade, spindle, etc. makes mounting, power supply, cable routing, signal transmission, etc. difficult to achieve; and the high stiffness of the component being measured will also affect the accuracy of the sensors. For tidal current power generation equipment, due to the complexity of the underwater environment, direct measurement of asymmetric loads presents greater challenges, and water flow and sediment impact can reduce the lifespan of sensors.

The invention provides a method based on indirect measurement for online measurement of the pitching and yawing moments of a wind or tidal current turbine, thus reducing the difficulty of implementation and improving the reliability and generalizability of the measurement.

### SUMMARY OF THE INVENTION

In order to solve the issues in the technical background, the invention provides a method that performs online indirect measurement of the pitching moment and the yawing moment of a wind turbine or a tidal current turbine with high reliability and low cost. It can obtain the pitching moment and the yawing moment of the wind or tidal current turbine in real time, which is easy to implement.

The technical solutions adopted by the invention are as follows:

1. An online indirect measurement system for a pitching and yawing moments of a wind or tidal current turbine includes an incoming flow (wind or tidal current) velocity measurement module, a generator rotation speed measurement module, a pitch angle measurement module, and a computer; the incoming flow velocity measurement module is used to measure a flow velocity of the rotor center of the turbine, the generator rotation speed measurement module is used to measure the rotation speed of the generator, the pitch angle measurement module is used to measure the pitch angle of each blade of the turbine. The incoming flow velocity measurement module, the generator rotation speed measurement module, and the pitch angle measurement module all implement a serial communication connection with the computer via communication cables to respectively transmit the signals of flow velocity, rotation speed, and pitch angle to the computer.

The computer calculates the pitching moment and yawing moment of the wind or tidal current turbine online according to the received signals of flow velocity, rotation speed, and pitch angle. All the received signals and calculated moments are also displayed and stored in real time.

For the wind turbine: the incoming flow velocity measurement module adopts a wind meter which is fixed at the top outside the nacelle; the generator rotation speed measurement module is mounted at the high-speed shaft of the gearbox in the nacelle; the pitch angle measurement module is arranged at the pitch system inside the rotor hub.

For the tidal current turbine: the incoming flow velocity measurement module adopts a tidal current velocity and direction meter arranged at the rotor center point directly in front of the tidal current direction; the generator rotation speed measurement module is mounted at the high-speed shaft of the gearbox inside the nacelle; the pitch angle measurement module is arranged at the pitch device inside the turbine rotor hub.

2. An online indirect measurement method for the pitching and yawing moments of a wind or tidal current turbine applied to the above system includes the following steps:
step 1) constructing a three-dimensional (3D) model of the turbine blade using a 3D modeling software, and obtaining the position coordinate of an equivalent loading point of force applied to the blade via a 3D simulation analysis, and calculating the distance between the equivalent loading point and the rotor center;
as shown in FIG. 4, obtaining the position coordinate of the equivalent loading point according to the blade characteristics such as airfoil, mass distribution, via 3D simulation analysis, and then calculating the distance between the equivalent loading point of blade and the rotor center;
step 2) transmitting the measured flow velocity signal, rotation speed signal, and pitch angle signal to the computer via the incoming flow velocity measurement module, the generator rotation speed measurement module, and the pitch angle measurement module respectively;
step 3) performing a filtering processing on the received flow velocity signal, rotation speed signal, and pitch angle signal via the computer to remove the noise interference; and calculating the pitching moment and the yawing moment of the wind or tidal current turbine in real time according to the distance between the equivalent loading point and the rotor center by the simulation analysis in step 1), and the filtered data of flow velocity, generator rotation speed, and pitch angle of each blade;
step 4) displaying the data of flow velocity, the generator rotation speed, and the pitch angle of each blade measured in step 2), and the calculated pitching moment and yawing moment in step 3) in real time via a monitoring interface and storing all of the above via the computer.

Step 3) is specifically:

3.1) Performing integration the generator rotation speed ω and adding it to the initial blade azimuth angle θᵢ′ of each blade to obtain the current blade azimuth angle θᵢ of each blade, where i=1, 2, . . . , N, and N is the total number of the blades. A specific formula is:

$${θ}_{i} = {θ}_{i}^{′} + {\int }_{0}^{t} \frac{ω}{n} dt$$

where n is the gearbox ratio of the turbine, and t is the system operating time.

3.2) According to the flow velocity vₛ of the rotor center, the current azimuth angle θᵢ of each blade, and the distance r_{c} between the equivalent loading point and the rotor center, the flow velocity vᵢ of each blade at the equivalent loading point of force applied to the blade can be calculated based on the flow shear formula. Specifically:

$${v}_{i} = {v}_{s} \cdot {( \frac{{z}_{h}}{{z}_{s}} )}^{α}$$

where vᵢ is the flow velocity at the equivalent loading point, zₕ is the vertical distance of the equivalent loading point from the ground (wind turbine) or the sea level (tidal current turbine), zₛ is the vertical distance of the rotor center from the ground or the sea level, vₛ is the flow velocity of the rotor center, and α is a shear coefficient.

When the distance between the equivalent loading points of the blades and the rotor center, the vertical distance of the rotor center from the ground or sea level, and the current azimuth angle θᵢ of each blade are known, the vertical distance zₕ of the equivalent loading point from the ground or sea level can be obtained via trigonometric transformations.

3.3) According to the generator rotation speed ω and the flow velocity vₛ of the rotor center, a blade tip speed ratio λ is calculated. A specific formula is:

$$λ = \frac{ω R}{n {v}_{s}}$$

where R is a distance between the blade tip and the rotor center.

According to the blade tip speed ratio λ and the pitch angle βᵢ of each blade measured by pitch angle measurement module, a rotor thrust coefficient C_{T} can be calculated via the blade element-momentum theory. According to the rotor thrust coefficient C_{T} and the flow velocity vₛ of the rotor center, the rotor thrust T is calculated. A specific calculation formula is:

$$T = \frac{1}{2} {C}_{T} ρ s {v}_{s}^{2}$$

where ρ is the air density (wind turbine) or the seawater density (tidal current turbine), and s is the rotor sweep area.

3.4) The non-axial moment M_{yi} of each blade is calculated. A specific calculation formula is:

$${M}_{y i} = \frac{{v}_{i}^{2}}{3 {v}_{s}^{2}} T {r}_{c}$$

3.5) The non-axial moments M_{yi} of all blades are decomposed along a pitch direction and a yaw direction and summing them separately to obtain the pitching moment Mₜᵢₗₜ and the yawing moment M_{yaw} of the rotor. A specific calculation formula is:

$$\{ \begin{matrix}{M}_{tilt} = {\sum }_{i = 1}^{N} {M}_{yi} sin {θ}_{i} \\ {M}_{yaw} = {\sum }_{i = 1}^{N} {M}_{yi} cos {θ}_{i}\end{matrix} .$$

In step 3.1), a two-dimensional coordinate system with the turbine hub as an origin is constructed, wherein the x-axis and y-axis are both located on the rotor rotation plane, the x-axis represents the horizontal axis on the rotor rotation plane, and the y-axis is the vertical axis on the rotor rotation plane; the blade azimuth angle refers to the rotation angle of the blade relative to the x-axis.

The beneficial effects of this invention are:
1. The use of indirect measurement method for online measurement of pitching and yawing moments avoids the difficulties, high costs, and low reliability associated with direct measurement methods. The measurement modules for incoming flow velocity, generator rotation speed, and pitch angle are highly reliable, the system is easy to construct while the method is easy to implement.
2. It enables reliable online measurement and real-time feedback of the pitching and yawing moments, providing key data for real-time monitoring of turbine operation status and active load control, and then improving the safety and reliability of the entire turbine operation.
3. The record of pitching and yawing moments data throughout the entire operation cycle of the turbine provides reliable data reference for the design process of turbine optimization, which avoids redundant design due to the lack of actual measured data on pitching and yawing moments, thereby reducing turbine design costs.

### BRIEF DESCRIPTION OF THE DRAWINGS

FIG. 1 is a schematic structural diagram of the system of the invention.

FIG. 2 is a schematic flowchart of the method of the invention.

FIG. 3 is a layout diagram of an embodiment of the system of the invention on the wind turbine.

FIG. 4 is a schematic structural diagram of the three-dimensional model of the turbine blade of the invention.

FIG. 5 is a layout diagram of an embodiment of the system of the invention on the tidal current turbine.

### DESCRIPTION OF THE EMBODIMENTS

The invention is further described in detail below with reference to the accompanying drawings and specific embodiments. However, it should be noted that the invention is not limited to the following specific embodiments.

### Embodiment 1

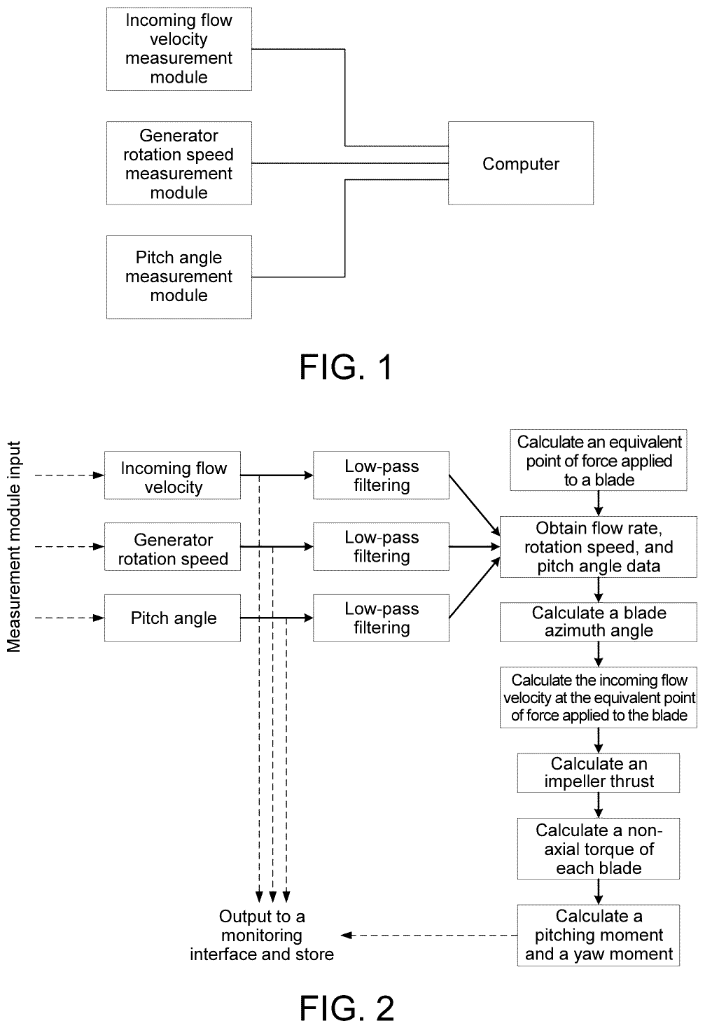

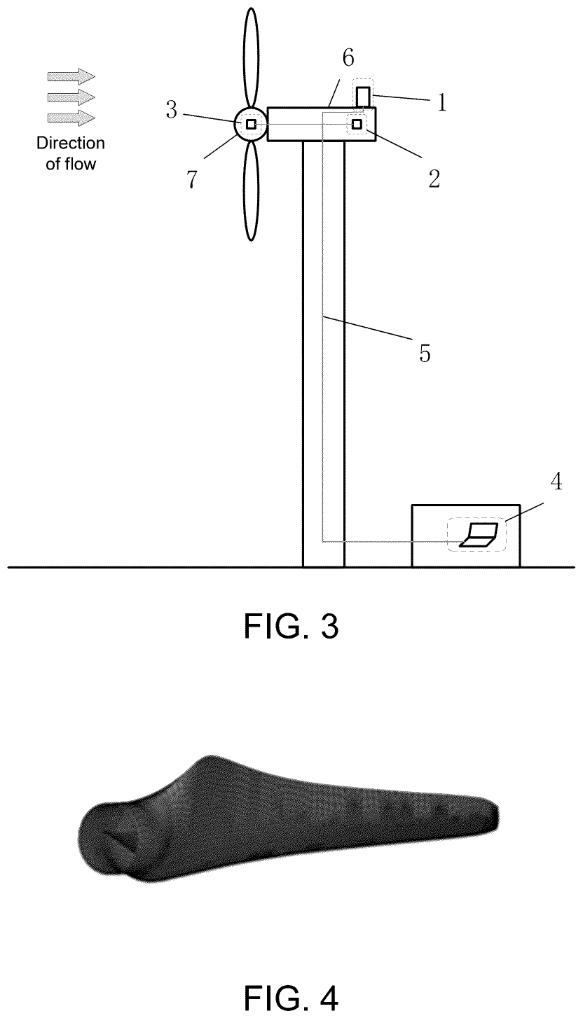

Referring to FIG. 1 and FIG. 3, the present embodiment provides an online indirect measurement system for pitching and yawing moments of a wind turbine, including an incoming flow velocity measurement module 1, a generator rotation speed measurement module 2, a pitch angle measurement module 3, and a computer 4. In particular, the incoming flow velocity measurement module 1 is used to measure the wind speed at the rotor center of the wind turbine; the generator rotation speed measurement module 2 is used to measure the generator rotation speed; the pitch angle measurement module 3 is used to measure the pitch angle of each blade; the computer 4 is used to receive the flow velocity signal, rotation speed signal, and pitch angle signal, and obtain the pitching moment and the yawing moment of the wind turbine via online real-time calculating and processing, and display and store the measurement and calculation data in real time.

The incoming flow velocity measurement module 1 adopts an anemometer arranged outside the wind turbine and fixed at the top of the nacelle.

The generator rotation speed measurement module 2 is arranged at the high-speed shaft of the gearbox inside the turbine nacelle 6; the pitch angle measurement module 3 is arranged at the pitch change device inside the turbine hub 7. The generator rotation speed measurement module 2 and pitch angle measurement module 3 are both located inside the turbine and remain relatively stationary. Therefore, the mounting is easy and the measurement reliability is high.

The incoming flow velocity measurement module 1, generator rotation speed measurement module 2, and pitch angle measurement module 3 are all connected to the computer 4 via communication cable 5, enabling serial communication. They respectively transmit the flow velocity signal, rotation speed signal, and pitch angle signal to the computer 4.

Referring to FIG. 2, this embodiment provides an online indirect measurement method for pitching and yawing moments of a wind turbine adopting the above online indirect measurement system for pitching and yawing moments of the wind turbine. The steps are as follows:
step 1) according to the blade design parameters of the wind turbine, a three-dimensional model of the wind turbine blades is established in the ANSYS Workbench software on the computer 4, as shown in FIG. 4. The three-dimensional simulation analysis is conducted, taking into account the blade's airfoil, mass distribution, and other characteristics. This analysis yields the coordinates of the equivalent loading points on the blades and calculates the distance between the equivalent loading points and the center of the rotor;
step 2) the incoming flow velocity measurement module 1, generator rotation speed measurement module 2, and pitch angle measurement module 3 are connected to the computer 4 via serial communication. During the actual operation of the turbine, the wind speed of the rotor center, the generator rotation speed, and the pitch angle of each blade are measured in real time. Subsequently, the signals for the wind speed, rotation speed, and pitch angle are transmitted to the computer 4;
step 3) the computer 4 receives the wind speed signal, rotation speed signal, and pitch angle signal transmitted by the modules in step 2), and applies filtering to remove noise interference. Utilizing the distance between the equivalent loading points on the blades and the rotor center obtained from the simulation in step 1), as well as the filtered wind speed, generator rotation speed, and pitch angle data, the computer 4 performs real-time calculations to determine the pitching moment and the yawing moment of the wind turbine;
the calculation process of the pitching moment and the yawing moment is as follows:

3.1) The generator rotation speed ω measured by the generator rotation speed measurement module 1 is integrated and then added to the initial azimuth angle βᵢ₀ of each blade, resulting in the current azimuth angle θᵢ of each blade. The wind turbine of this present embodiment is designed with three blades, and the value of i ranges from {1, 2, 3};

$${θ}_{i} = {θ}_{i}^{′} + {\int }_{0}^{t} \frac{ω}{n} dt$$

where n is the gearbox ratio of the turbine, and t is the system operating time;
a two-dimensional coordinate system with the turbine hub as the origin is constructed, wherein the x-axis and y-axis are both located on the rotor rotation plane, the x-axis represents the horizontal axis on the rotor rotation plane, and the y-axis is the vertical axis on the rotor rotation plane. The blade azimuth angle refers to the rotation angle of the blade relative to the x-axis.

3.2) According to the wind speed vₛ measured at the rotor center by the incoming flow velocity measurement module 2, as well as the current azimuth angle θᵢ of each blade and a distance r_{c} between the equivalent loading point and the rotor center, the wind speed vᵢ at the equivalent loading point of each blade is calculated. The calculation method is based on the shear flow formula:

$${v}_{i} = {v}_{s} \cdot {( \frac{{z}_{h}}{{z}_{s}} )}^{α}$$

In the equation, zₕ is the height above the ground of the desired location, vᵢ is the wind speed at the desired location, zₛ is the height above the ground of the rotor center, vₛ is the wind speed at the rotor center, and α is the shear coefficient. The desired location refers to the equivalent force application point of the desired blade.

When the distance between the equivalent loading points of the blades and the rotor center, the height of the rotor center above the ground, and the current azimuth angle θᵢ of each blade are known, the height zₕ of the equivalent loading point above the ground can be obtained via trigonometric transformations.

3.3) According to the generator rotation speed ω and the wind speed vₛ of the rotor center, a blade tip speed ratio λ is calculated. The specific formula is:

$$λ = \frac{ω R}{n {v}_{s}}$$

where R is the distance between the blade tip and the rotor center.

According to the blade tip speed ratio λ and the pitch angle βᵢ of each blade measured by the pitch angle measurement module, a rotor thrust coefficient C_{T} is calculated via the blade element-momentum theory. According to the thrust coefficient C_{T} and the wind speed vₛ of the rotor center, the rotor thrust T is calculated. The calculation formula is:

$$T = \frac{1}{2} {C}_{T} ρ s {v}_{s}^{2}$$

where ρ is the air density, and s is the rotor sweep area.

3.4) The non-axial moment M_{yi} of the blade i is calculated. The calculation formula is:

$${M}_{y i} = \frac{{v}_{i}^{2}}{3 {v}_{s}^{2}} T {r}_{c}$$

3.5) The non-axial moments M_{yi} of three blades are decomposed along the pitch direction and the yaw direction and summing them respectively to obtain the pitching moment Mₜᵢₗₜ and the yawing moment M_{yaw} of the rotor. The calculation formula is:

$$\{ \begin{matrix}{M}_{tilt} = {\sum }_{i = 1}^{3} {M}_{yi} sin {θ}_{i} \\ {M}_{yaw} = {\sum }_{i = 1}^{3} {M}_{yi} cos {θ}_{i}\end{matrix}$$

Step 4) the computer 4 takes the measured data of wind speed, generator rotation speed, and pitch angle obtained in step 2), as well as the calculated pitching moment and yawing moment in step 3), and displays them in real-time on the monitoring interface. Additionally, all the data is stored.

### Embodiment 2

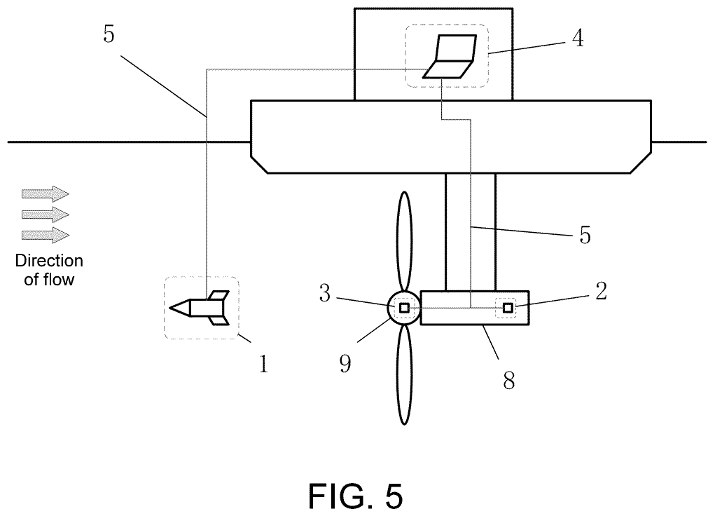

Referring to FIG. 1, FIG. 2, and FIG. 5, this embodiment provides an online indirect measurement system and method for pitching and yawing moments of a tidal current turbine.

In this embodiment, the provided online indirect measurement system for pitching and yawing moments of the tidal current turbine is essentially similar to the one in Embodiment 1. The difference lies in the following aspects: the incoming flow velocity measurement module 1 is used to measure the tidal current velocity at the center of the tidal current turbine rotor; the incoming flow velocity measurement module 1 employs a current velocity and direction meter, which is positioned at an appropriate distance ahead of the center point of the tidal energy turbine rotor in the direction of the flow.

In this embodiment, the provided online indirect measurement method for pitching and yawing moments of the tidal current turbine is essentially similar to the one in Embodiment 1. The difference lies in the following aspects: a three-dimensional model of the tidal current turbine blades for simulation analysis is established; the wind speed readings, calculations, displays, and storage is replaced with tidal current velocity; during the calculation process, zₕ is the vertical distance of the desired point from the seabed level, zₛ is the vertical distance of the rotor center from the seabed level, and p is the seawater density.

The above description only outlines the basic principles and preferred embodiments of the invention. Any modifications, equivalent substitutions, and improvements, etc. made within the spirit and principles of the invention are all included in the scope of the invention.

What is claimed is:

1. An online indirect measurement method for pitching and yawing moments of wind or tidal current turbine,
wherein the online indirect measurement method adopts an online indirect measurement system for the pitching and yawing moments of the wind or tidal current turbine, the system comprises an incoming flow velocity measurement module, a generator rotation speed measurement module, a pitch angle measurement module, and a computer; the incoming flow velocity measurement module is used to measure a flow velocity at a center of the turbine rotor, the generator rotation speed measurement module is used to measure a rotation speed of the turbine generator, and the pitch angle measurement module is used to measure a pitch angle of each blade of the rotor, and the incoming flow velocity measurement module, the generator rotation speed measurement module, and the pitch angle measurement module all implement a serial communication connection with the computer via communication cables to respectively transmit signals of the flow velocity, the rotation speed, and the pitch angle to the computer,
wherein the method comprises the following steps:
step 1) constructing a three-dimensional (3D) model of the turbine blade by using a 3D modeling software, and obtaining the position coordinate of an equivalent loading point of force applied to the blade via a 3D simulation analysis, and calculating a distance between the equivalent loading point and the rotor center;
step 2) transmitting the measured flow velocity signal, rotation speed signal, and pitch angle signal to the computer respectively via the incoming flow velocity measurement module, the generator rotation speed measurement module, and the pitch angle measurement module;
step 3) performing a filtering processing on the received flow velocity signal, rotation speed signal, and pitch angle signal via the computer to remove noise interferences; and calculating the pitching moment and the yawing moment of the wind or tidal current turbine in real time according to the distance between the equivalent loading point and the rotor center obtained by the simulation in step 1), and according to filtered data of the flow velocity, generator rotation speed, and the pitch angle of each blade;
step 4) displaying the data of flow velocity, the generator rotation speed, and the pitch angle of each blade measured in step 2), and the calculated pitching moment and yawing moment in step 3) in real time via a monitoring interface and storing all of the above via the computer;
step 3) is specifically:
3.1) performing integration the generator rotation speed ω and adding it to the initial azimuth angle θᵢ′ of each blade to obtain the current blade azimuth angle θᵢ of each blade, where i=1, 2˜N, and Nis the total number of the blades, and a specific formula is:
$${θ}_{i} = {θ}_{i}^{′} + {\int }_{0}^{t} \frac{ω}{n} dt$$
where n is the gearbox ratio of the turbine, and t is the system operating time;
3.2) calculating the flow velocity vᵢ of each blade at the equivalent point of force applied to the blade based on the flow shear formula, according to the flow velocity vₛ of the rotor center, the current azimuth angle θᵢ of each blade, and the distance r_{c} between the equivalent point and the rotor center, specifically:
$${v}_{i} = {v}_{s} \cdot {( \frac{{z}_{h}}{{z}_{s}} )}^{α}$$
where vᵢ is the flow velocity at the equivalent loading point, zₕ is a vertical distance of the equivalent loading point from a ground or a seabed level, zₛ is a vertical distance of the rotor center from the ground or the seabed level, vₛ is the flow velocity of the rotor center, and α is a shear coefficient;
3.3) calculating a blade tip speed ratio λ according to the generator rotation speed ω and the flow velocity vₛ of the rotor center, and a specific formula is:
$$λ = \frac{ω R}{n {v}_{s}}$$
where R is a distance between a blade tip and the rotor center;
calculating a rotor thrust coefficient C_{T} via a blade element-momentum theory according to the blade tip speed ratio λ and a pitch angle βᵢ; of each blade measured by the pitch angle measurement module; and calculating a rotor thrust T according to the rotor thrust coefficient C_{T} and the flow velocity vₛ of the rotor center, and a specific calculation formula is:
$$T = \frac{1}{2} {C}_{T} ρ s {v}_{s}^{2}$$
wherein in the formula, ρ is an air density or a seawater density, and s is a rotor sweep area;
3.4) calculating a non-axial moment M_{yi} of each blade, and a specific calculation formula is:
$${M}_{y i} = \frac{{v}_{i}^{2}}{3 {v}_{s}^{2}} T {r}_{c}$$
3.5) decomposing the non-axial moments M_{yi} of all blades along a pitch direction and a yaw direction and summing them separately to obtain a pitching moment Mₜᵢₗₜ and a yawing moment M_{yaw} of the rotor, and a specific calculation formula is:
$$\{ \begin{matrix}{M}_{tilt} = {\sum }_{i = 1}^{N} {M}_{yi} sin {θ}_{i} \\ {M}_{yaw} = {\sum }_{i = 1}^{N} {M}_{yi} cos {θ}_{i}\end{matrix} .$$

2. The online indirect measurement method for pitching and yawing moments of the wind or tidal current turbine according to claim 1, wherein in step 3.1), a two-dimensional coordinate system with a turbine hub as an origin is constructed, wherein an x-axis and a y-axis are both located on a rotor rotation plane, the x-axis represents a horizontal axis on the rotor rotation plane, and the y-axis is a vertical axis on the rotor rotation plane; a blade azimuth angle refers to the rotation angle of the blade relative to the x-axis.
